(19) United States
(12) Patent Application Publication
(10) Pub. No.: US 2008/0212430 A1
(43) Pub. Date: Sep. 4, 2008

(54) Method and System for Scanning an Information Carrier Via One-Dimensional Scanning

(75) Inventors: Levinus Pieter Bakker, Eindhoven (NL); R.F.M. Hendriks, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/089,776

(22) PCT Filed: Oct. 11, 2006
(86) PCT No.: PCT/IB06/53728

§ 371 Date: Apr. 10, 2008

(30) Foreign Application Priority Data
Oct. 14, 2005 (CN) 200510113554.3

(51) Int. Cl. G11B 7/00

(52) U.S. Cl. 369/53.11

(57) ABSTRACT

A system for reading an information carrier having a data layer (101) on which is stored a data set. A probe array generating means (104) generates an array of light spots (102) which is applied to the data layer (101). The resultant output light beams are representative of the binary value of data stored in the data layer (101). Macro-cell scanning is effected in a single dimension by moving the array of light spots (102) relative to the data layer (101) along a path (A,B) which is non-parallel to the axes of the matrix defining the probe array. One-dimensional scanning results in a less complex system.

### FIELD OF THE INVENTION

The invention relates to a method and system for scanning an information carrier. The invention has applications in the field of optical data storage and microscopy.

### BACKGROUND OF THE INVENTION

The use of optical storage solutions is nowadays widespread for content distribution, for example in storage systems based on the DVD (Digital Versatile Disc) standards. Optical storage has a big advantage over hard-disc and solid-state storage in that the information carrier are easy and cheap to replicate.

However, due to the large amount of moving elements in the drives, known applications using optical storage solutions are not robust to shocks when performing read/write operations, considering the required stability of said moving elements during such operations. As a consequence, optical storage solutions cannot easily and efficiently be used in applications which are subject to shocks, such as in portable devices.

New optical storage solutions have thus been developed. These solutions combine the advantages of optical storage in that a cheap and removable information carrier is used, and the advantages of solid-state storage in that the information carrier is robust to shocks and that its reading requires a limited number of moving elements.

FIG. 1 depicts a three-dimensional view of a system illustrating such an optical storage solution.

This system comprises an information carrier 101. The information carrier 101 comprises a set of adjacent elementary data areas having size S and arranged as in a matrix. Data are coded on each elementary data area via the use of a material intended to take different transparency levels, for example two levels in using a material being transparent or non-transparent for coding a 2-states data, or more generally N transparency levels (for example N being an integer power of 2 for coding a log₂(N)-states data). This system also comprises an optical device 104 (such as a periodic array of apertures or an array of optical fibres) for generating an array of light spots 102 which are intended to be applied to said elementary data areas.

Each light spot is intended to be applied to an elementary data area. According to the transparency state of said elementary data areas, the light spot is transmitted (not at all, partially or fully) to a CMOS or CCD detector 103 comprising pixels intended to convert the received light signal, so as to recover the data stores on said elementary data area.

To read the information carrier, a scanning of the information carrier 101 by the array of light spots 102 is done in a plane (x,y) parallel to the information carrier. A scanning device (not shown) provides translational movement in the two directions x and y for scanning all the surface of the information carrier.

Advantageously, one pixel of the detector is intended to detect a set of elementary data, said set of elementary data being arranged in a so-called macro-cell data, each elementary data area among this macro-cell data being successively read by a single light spot of said array of light spots 102. This way of reading data on the information carrier 101 is called macro-cell scanning in the following and will be described after.

FIG. 2 depicts a partial cross-section and detailed view of the information carrier 101, and of the detector 103.

The detector 103 comprises pixels referred to as PX1-PX2-PX3, the number of pixels shown being limited for facilitating the understanding. In particular, pixel PX1 is intended to detect data stored on the macro-cell data MC1 of the information carrier, pixel PX2 is intended to detect data stored on the macro-cell data MC2, and pixel PX3 is intended to detect data stored on the macro-cell data MC3. Each macro-cell data comprises a set of elementary data. For example, macro-cell data MC1 comprises elementary data referred to as MC1a-MC1b-MC1c-MC1d.

FIG. 3 illustrates by an example the macro-cell scanning of the information carrier 101. For simplicity, only 2-states data are considered, similar explanations holding for an N-state coding. Data stored on the information carrier have two states indicated either by a black area (i.e. non-transparent) or white area (i.e. transparent). For example, a black area corresponds to a “0” binary state while a white area corresponds to a “1” binary state.

When a pixel of the detector 103 is illuminated by an output light beam generated by the information carrier 101, the pixel is represented by a white area. In that case, the pixel delivers an electric output signal (not represented) having a first state. On the contrary, when a pixel of the detector 103 does not receive any output light beam from the information carrier, the pixel is represented by a cross-hatched area. In that case, the pixel delivers an electric output signal (not represented) having a second state.

In this example, each macro-cell data comprises four elementary data areas, and a single light spot is applied simultaneously to each set of data. The scanning of the information carrier 101 by the array of light spots 102 is performed for example from left to right, with an incremental lateral displacement which equals the pitch of the elementary data areas.

In position A, all the light spots are applied to non-transparent areas so that all pixels of the detector are in the second state.

In position B, after displacement of the light spots to the right, the light spot to the left side is applied to a transparent area so that the corresponding pixel is in the first state, while the two other light spots are applied to non-transparent areas so that the two corresponding pixels of the detector are in the second state.

In position C, after displacement of the light spots to the right, the light spot to the left side is applied to a non-transparent area so that the corresponding pixel is in the second state, while the two other light spots are applied to transparent areas so that the two corresponding pixels of the detector are in the first state.

In position D, after displacement of the light spots to the right, the central light spot is applied to a non-transparent area so that the corresponding pixel is in the second state, while the two other light spots are applied to transparent areas so that the two corresponding pixels of the detector are in the first state.

Elementary data which compose a macro-cell opposite a pixel of the detector are read successively by a single light spot. The scanning of the information carrier 101 is complete when the light spots have each been applied to all elementary data area of a macro-cell data facing a pixel of the detector. This implies a two-dimensional scanning of the information carrier.

FIG. 4 represents a top-view of an information carrier 101 as depicted in FIG. 1. This information carrier comprises a plurality of square adjacent macro-cells (MC1, MC2, MC3 . . . ), each macro-cell comprising a set of elementary data areas (EDA1, EDA2 . . . ). In this example, each macro-cell comprises 16 elementary data areas and is intended to be read by a single circular light spot (represented by black circles).

The data recovery is done in a massively parallel manner concurrently with the scanning of the array of light spots. For each position of the array of light spots, a set of data called “data page” is read at the same time. A data page is thus constituted by data on which is applied the light spots at a given instant, said data being located at the same position in all macro-cells.

Thus, in the system described above, an optical probe array is used to read an optical card and, in order to increase the density (data capacity) of the optical card, a macro-cell scanning system has been proposed. In this system, the probe array is scanned in two dimensions over the pixels of a CMOS sensor. Alternatively, the medium is scanned in two dimensions with respect to the probe array and the CMOS sensor. In both cases, a two-dimensional scanning apparatus is used to perform the required relative displacement in two directions.

However, such two-dimensional scanning apparatus is relatively complex.

### OBJECT AND SUMMARY OF THE INVENTION

It is an object of the present invention to provide a system for scanning an information carrier in which scanning of an information carrier by an array of light spots is performed and wherein the complexity of the scanning apparatus is reduced.

In accordance with the present invention, there is provided a system for scanning an information carrier, the system comprising:
a probe array generating means comprising an optical device for generating an array of light spots arranged in a regular pattern of rows and columns for application to said information carrier,
scanning means for effecting relative movement of said array of light spots and said information carrier along a path which is non-parallel relative to said rows and columns of light spots.

Also in accordance with the present invention, there is provided a method for scanning an information carrier, the method comprising:
generating a probe array comprising a regular pattern of rows and columns of light spots and applying said probe array to said information carrier so as to generate respective output light beams;
receiving said output light beams; and
scanning said information carrier with said probe array by causing relative movement therebetween along a single path which is non-parallel relative to said rows and columns of light spots.

The present invention extends to information carrier reading apparatus comprising means for receiving an information carrier having a data layer on which a data set is stored, a system as defined above for reading the information carrier, and means for generating an output representative of a data set read from the information carrier.

Thus, the object of the present invention is achieved by using one-dimensional scanning of the information carrier with the array of light spots, instead of the two-dimensional scanning known from prior art systems, wherein said one-dimensional scanning is achieved by scanning a direction that is non-parallel relative to the probe array (i.e. the array of light spots). This is highly advantageous since a one-dimensional scanner is less complex than a two-dimensional one, even though the stroke of a one-dimensional scanner needs to be larger than that of a two-dimensional scanner.

In one exemplary embodiment, the information carrier comprises data organized in cells having a horizontal and a vertical axis, the rows and columns of light spots being substantially parallel with said horizontal and vertical axes, and the path of relative movement of said probe array and said data layer is at an angle relative to said horizontal and vertical axes. In an alternative exemplary embodiment, the rows and columns of light spots are at an angle relative to the horizontal and vertical axes respectively, and the path of relative movement of said probe array is either at another angle relative to said horizontal and vertical axes or, more preferably, substantially parallel to the horizontal or vertical axis. It will be appreciated that the rows may be tilted relative to the horizontal axis by a first angle and the columns may be filled relative to the vertical axis by a second angle which may be the same or different to the first angle. Thus the rows and columns may be substantially 90° relative to each other or they may be at a different angle relative to each other. It will be further appreciated that the rows may have the same or a different number of probes (light spots) to the columns and the present invention is not necessarily intended to be limited in respect of these issues.

The area of the probe array is beneficially larger than that of the data layer, such that the entire data layer can be scanned in one dimension by the probe array.

It will be appreciated that relative movement of the probe array and information carrier may be effected by movement of the probe array relative to the information carrier and/or movement of the information carrier relative to the probe array.

These and other aspects of the present invention will be apparent from, and elucidated with reference to, the embodiments described herein.

### BRIEF DESCRIPTION OF THE DRAWINGS

Embodiments of the present invention will now be described by way of examples only and with reference to the accompanying drawings, in which:

FIG. 1 is a schematic diagram illustrating a system for reading an information carrier;

FIG. 2 illustrates schematically a more detailed view of the system of FIG. 1;

FIG. 3 illustrates by example the principle of macro-cell scanning of an information carrier;

FIG. 4 is a schematic diagram illustrating an information carrier intended to be read by a plurality of light spots;

FIG. 5 is a schematic diagram illustrating a rectangular probe array and a scanning direction in respect thereof in a system according to a first exemplary embodiment of the present invention;

FIG. 6 is a schematic diagram illustrating a complete scanning process in respect of the probe array of FIG. 5;

FIG. 7 is a schematic diagram illustrating a probe array and a scanning direction in respect thereof in a system according to a second exemplary embodiment of the present invention; and

FIG. 8 illustrates various devices implementing the method according to the invention.

### DETAILED DESCRIPTION OF THE INVENTION

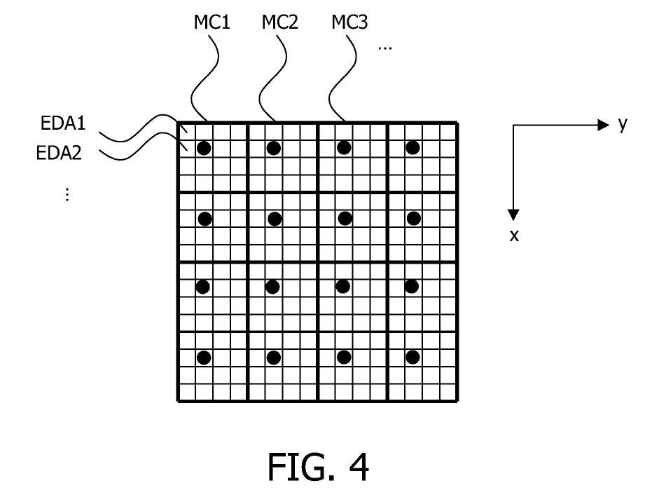

In the following, the invention will be described with the assumption that data to be recovered are stored in data pages in an information carrier such as that depicted in FIG. 4. Since this information carrier contains data arranged in a matrix, the macro-cells also contain elementary data arranged in a matrix.

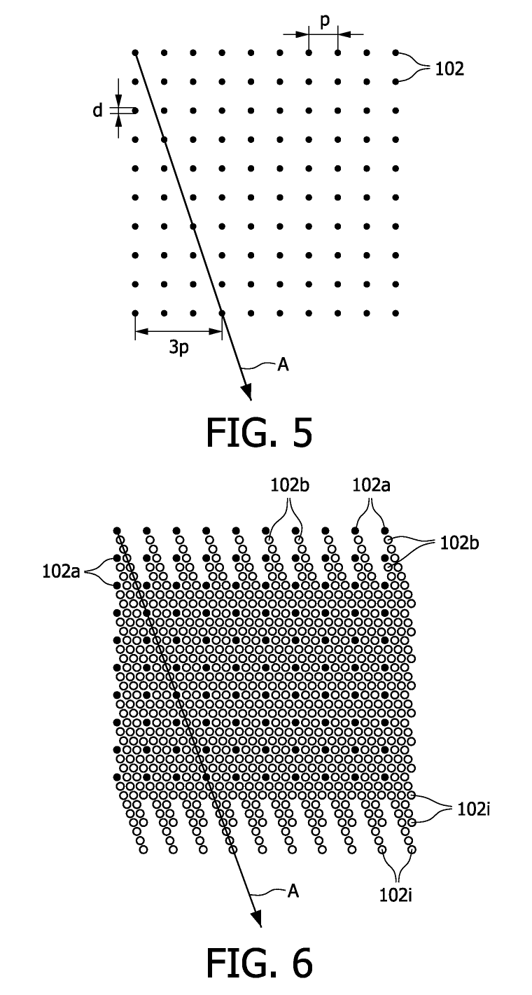

Referring to FIG. 5 of the drawings, there is illustrated schematically a rectangular probe array comprising a matrix of light spots 102. This probe array can be scanned across the data layer of the information carrier (not shown) in the direction indicated by the arrow A. It will be appreciated that such scanning may be achieved by movement of the light spots 102 relative to the information carrier or by means of movement of the information carrier relative to the light spots.

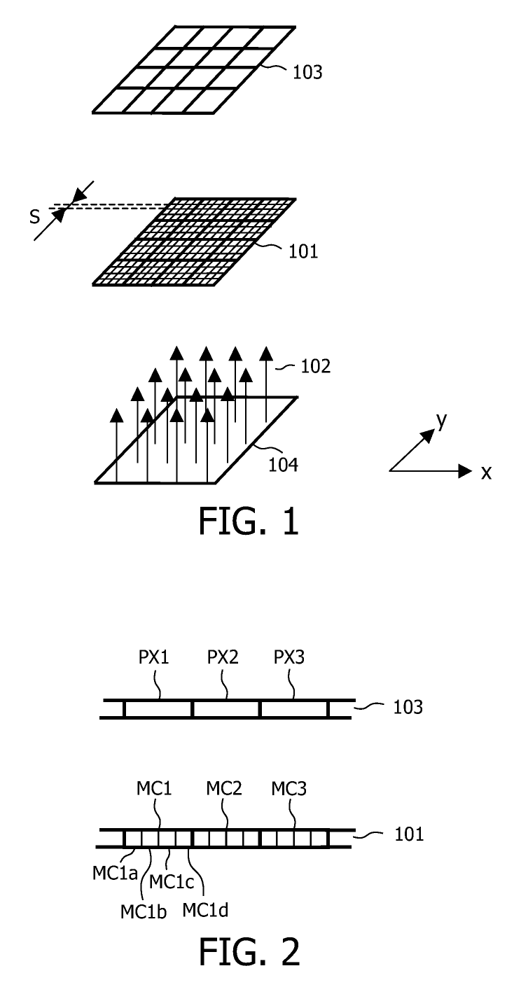

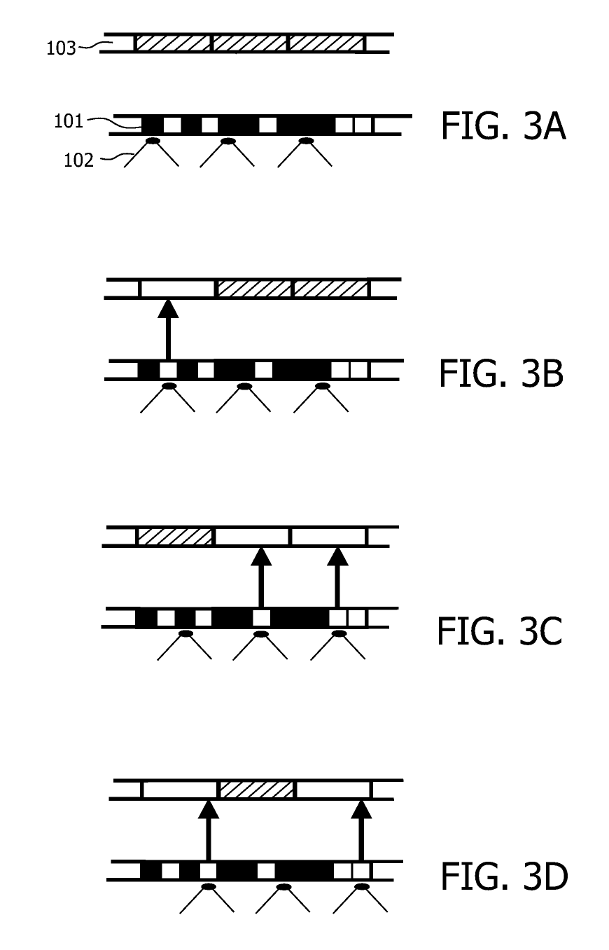

As shown, the scanning direction A is non-parallel to the matrix defining the probe array. The size of each probe or light spot 102 in the arrangement of FIG. 1 is one third of the pitch p of the probe array and the scanning direction A in the arrangement of FIG. 1 is optimally chosen in such a way that, when the array is scanned over 3 pitches (3p), the displaced array overlaps the original position of the array. When the array is scanned in steps equal to the diameter d of the light spots 102, over 3*3−1=8 steps, the situation illustrated in FIG. 6 occurs, wherein the light spots denoted 102a indicate the initial position of the probe array and the light spots denoted 102b . . . 102i indicate the respective positions of the probe array for each scanning step. It is clear from this that scanning the array over 3*3−1=8 steps results in having read all the data on the card.

It will be clear from FIG. 6 that, in order to read all of the data on the data card using the one-dimensional scanning process of the present invention, the probe array needs to be larger than the area of the data layer to be read (note that the upper two rows of the probe array illustrated in FIG. 6 are not completely filled). When the multiplexing factor M is defined as the ratio of array pitch p to probe size d, it can be seen that M−1 rows are not completely filled during the scanning process, and M²−1 steps are required to fill the whole surface of the data layer, whereas using the two-dimensional scanning process of the prior art, M−1 steps in both directions would be required. Thus, the stroke of the one-dimensional scanning apparatus used in the system of the present invention is:

$$\frac{{M}^{2} - 1}{M - 1} = M + 1$$

larger than the stroke of the two-dimensional scanning device.

The one-dimensional scanning principle employed in the present invention can also be used in respect of larger data density applications, such as that used in the so-called Two-Dimensional Optical Storage (TwoDOS) approach, aiming at demonstrating the feasibility of real-time, robust readout of a single layer disc with a capacity of at least 50 GB and at a data rate of more than 360 Mbit/s. Spacing between tracks on an optical information carrier limits attainable storage capacity, while the serial nature of the data in a one-dimensional optical storage system limits the attainable data throughput. As a result, the concept of TwoDOS has been developed which is based on innovative two-dimensional channel coding and advanced signal processing, in combination with a read-channel consisting of a multi-spot light path realizing a parallel read-out.

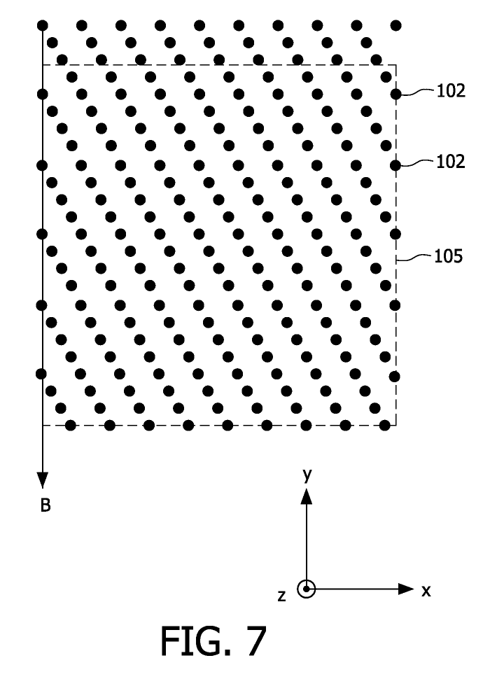

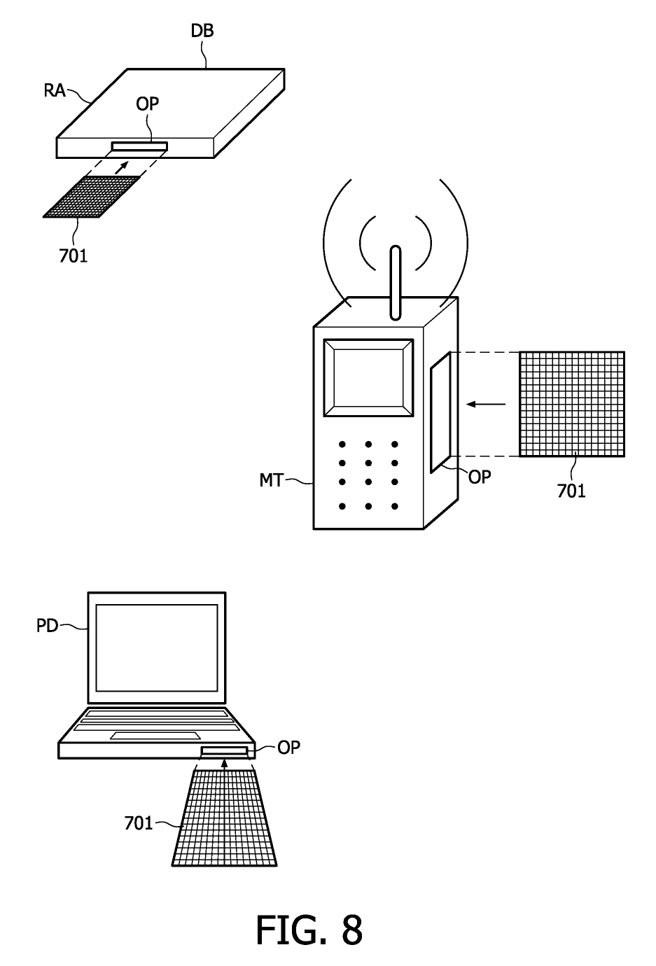

Referring to FIG. 7 of the drawings, in a second exemplary embodiment of the present invention suitable for use in larger data density applications, the probe array has been effectively rotated about a generally central z axis, such that the rows and columns of light spots 102 are effectively at an angle to the x and y axes respectively, and the scanning direction, indicated by the arrow B, is parallel to the y axis. The data area 105 is also shown and it can be seen that, in addition to the main advantage of the present invention whereby a one-dimensional scanner can be used instead of a two-dimensional scanner, because the number of probes 102 has been increased relative to that in the array of FIGS. 1 and 2, the required scanning stroke in this case is much smaller than M−1. The effect of cross-talk between two neighbouring data bits can be reduced using the TwoDOS approach (since inter-symbol interference, which is considered to be noise in the case of one-dimensional storage, is considered to be part of the signal in the 2D case and, as such is used in the respective bit pattern reconstruction) and by means of a system wherein read data pages can be stored in a buffer memory and subsequently recovered using dedicated data recovering algorithms in the digital processing domain. In this case, an additional advantage of the scanning system of FIG. 7 is that the capacity of the buffer memory required for cross-talk cancellation is reduced, thereby contributing to define a cost-effective system.

It will be appreciated that the angle of the rows and columns of light spots relative to the x and y axes in the embodiment illustrated in FIG. 7 can be varied, as can the pitch of the light spots on the lines.

In all cases, the probe array can be produced using the known diffraction phenomena referred to as “Talbot effect”, whereby when a coherent input light beam is applied to an object having a periodic diffractive structure (thus forming light emitters), such as an array of apertures, the diffracted lights recombine into identical images of the emitters at a plane located at a predictable distance (z0), i.e. the Talbot distance, from the diffracting structure.

Thus, the present invention provides a system for reading an information carrier (or “data card”), whereby a one-dimensional scanner can be used to read out the full area of the data card, such that the resultant reader becomes less complex relative to prior art systems in which a two-dimensional scanner is used.

As illustrated in FIG. 8, the system and method according to the invention may advantageously be implemented in a reading apparatus RA (e.g. home player apparatus . . . ), a portable device PD (e.g. portable digital assistant, portable computer, a game player unit . . . ), a mobile telephone MT. Each of these devices comprises an opening (OP) intended to receive an information carrier 701 as depicted in FIG. 4, in view of a data recovery.

The scanning system in accordance with the invention may be used in a microscope. Microscopes with reasonable resolution are expensive, since an aberration-free objective lens with a reasonably large field of view and high enough numerical aperture is costly. Scanning microscopes solve this cost issue partly by having an objective lens with a very small field of view, and scanning the objective lens with respect to the sample to be measured (or vice-versa). The disadvantage of this single-spot scanning microscope is the fact that the whole sample has to be scanned, resulting in cumbersome mechanics. Multi-spot scanning microscopes solve this mechanical problem, since the sample does not have to be scanned over its full dimensions, the scanning range is limited to the pitch between two spots.

In a microscope in accordance with the invention, a sample is illuminated with the spots that are created by the probe array generating means, and a camera takes a picture of the illuminated sample. By scanning the spots over the sample by means of the one-dimensional scanning system of the invention, and taking pictures at several positions, high-resolution data are gathered. A computer may combine all the measured data to a single high-resolution picture of the sample.

The focus distance can be controlled manually, by looking at a detail of the picture of the sample. It can also be performed automatically, as is done in a digital camera (finding the position in which the picture has the maximum contrast). Note that the focusing of the imaging system is not critical, only the position of the sample with respect to the probes is important and should be optimized.

A microscope in accordance with the invention consists of an illumination device, a probe array generator, a sample stage, optionally an imaging device (e.g. lens, fiber optic face plate, mirror), and a camera (e.g. CMOS, CCD). This system corresponds to the system of FIG. 1, wherein the information carrier (101) is a microscope slide on which a sample to be imaged may be placed, the microscope slide being deposited on a sample stage. Light is generated in the illumination device, is focused into an array of foci by means of the probe array generator, it is transmitted (partly) through the sample to be measured, and the transmitted light is imaged onto the camera by the imaging system. The sample is positioned in a sample stage, which can reproducibly move the sample in the focal plane of the foci and perpendicular to the sample. A position measurement system can be implemented into the stage, or it can be implemented in the system. In order to image the whole sample, the information carrier is scanned by means of the scanning system in accordance with the invention so that all areas of the sample are imaged by an individual probe. As described above, the number of steps required for the scanning depends on the size of each probe and the pitch between two probes.

Instead of a transmissive microscope as described above, a reflective microscope may be designed. In a reflective microscope in accordance with the invention, light that has passed through the sample is reflected by a reflecting surface of the microscope slide and then redirected to the camera by means of a beam splitter.

It should be noted that the above-mentioned embodiments illustrate rather than limit the invention, and that those skilled in the art will be capable of designing many alternative embodiments without departing from the scope of the invention as defined by the appended claims. In the claims, any reference signs placed in parentheses shall not be construed as limiting the claims. The word “comprising” and “comprises”, and the like, does not exclude the presence of elements or steps other than those listed in any claim or the specification as a whole. The singular reference of an element does not exclude the plural reference of such elements and vice-versa. The invention may be implemented by means of hardware comprising several distinct elements, and by means of a suitably programmed computer. In a device claim enumerating several means, several of these means may be embodied by one and the same item of hardware. The mere fact that certain measures are recited in mutually different dependent claims does not indicate that a combination of these measures cannot be used to advantage.

1. A system for scanning an information carrier the system comprising:
a probe array generating means (104) comprising an optical device for generating an array of light spots (102) arranged in a regular pattern of rows and columns for application to said information carrier,
scanning means for effecting relative movement of said array of light spots (102) and said information carrier along a non-parallel path (A,B) relative to said rows and columns of light spots (102).

2. A system according to claim 1, wherein the information carrier comprises data organized in cells having a horizontal and a vertical axis, the rows and columns of light spots (102) being substantially parallel with said horizontal and vertical axes, and the path (A) of relative movement of said array and said information carrier is at an angle relative to said horizontal and vertical axes.

3. A system according to claim 1, wherein the information carrier comprises data organized in cells having a horizontal and a vertical axis, the rows and columns of light spots (102) are at an angle relative to the horizontal and vertical axis respectively, and the path (B) of relative movement of said array and said information carrier is either at another angle relative to said horizontal and vertical axes or substantially parallel to the horizontal or vertical axis.

4. A system according to claim 1, wherein relative movement of the probe array and information carrier is effected by movement of the array of light spots (102) relative to the information carrier.

5. A system according to claim 1, wherein relative movement of the probe array and information carrier is effected by movement of the information carrier (101) relative to the array of light spots (102).

6. A method for scanning an information carrier, the method comprising:
generating a probe array comprising a regular pattern of rows and columns of light spots (102) and applying said probe array to said information carrier so as to generate respective output light beams;
receiving said output light beams; and
scanning said information carrier with said probe array by causing relative movement therebetween along a single, non-parallel path (A,B) relative to said rows and columns of light spots (102).

7. An information carrier reading apparatus comprising means for receiving an information carrier (101) having a data layer on which a data set (105) is stored, a system according to claim 1 for reading the information carrier (101), and means for generating an output representative of a data set (105) read from the information carrier (101).

8. A microscope comprising means for receiving an information carrier on which a sample to be imaged can be deposited, and a system according to claim 1 for scanning said information carrier.
